(19) United States
(12) Patent Application Publication
(10) Pub. No.: US 2025/0070902 A1
(43) Pub. Date: Feb. 27, 2025

(54) AI/ML MODEL TEST MECHANISM

(71) Applicant: Nokia Technologies Oy, Espoo (FI)

(72) Inventors: Deepa MALAPATI RAVINDRAIAH, Bangalore (IN); Afef FEKI, Massy (FR); Fahad SYED MUHAMMAD Fahad, Massy (FR); Dimitri GOLD, Espoo (FI); Muhammad Ikram ASHRAF, Espoo (FI)

(21) Appl. No.: 18/798,373

(22) Filed: Aug. 8, 2024

(30) Foreign Application Priority Data
Aug. 21, 2023 (IN) 202341055825

(51) Int. Cl. H04B 17/391; H04B 17/373; H04L 41/16

(52) U.S. Cl. CPC H04B 17/3913; H04B 17/373; H04L 41/16

(57) ABSTRACT

Example embodiments of the present disclosure are related to artificial intelligence/machine learning (AI/ML) model test. A first apparatus transmits test configuration information to a second apparatus, the test configuration information indicating a test mode of an AI/ML model with respect to at least one transmission and reception unit (TRP), the at least one TRP being arranged within an environment based on a test plan for at least one test channel indicator. The first apparatus receives, from the second apparatus, at least one predicted channel indicator for the at least one TRP, the at least one predicted channel indicator being derived by the second apparatus using the AI/ML model. The first apparatus determines a test result for the AI/ML model based on a comparison between the at least one predicted channel indicator and the at least one test channel indicator, the test result indicating whether the AI/ML model is validated.

### CROSS-REFERENCE TO RELATED APPLICATION

The present disclosure claims priority from, and the benefit of, India Provisional Application No. 202341055825, filed Aug. 21, 2023, the contents of which are hereby incorporated by reference in their entirety.

### FIELDS

Various example embodiments of the present disclosure generally relate to the field of telecommunication and in particular, to methods, devices, apparatuses and computer readable storage medium for artificial intelligence/machine learning (AI/ML) model test.

### BACKGROUND

In the telecommunication industry, artificial intelligence/machine learning (AI/ML) have been employed in telecommunication systems to improve the performance. The 3rd Generation Partnership Project (3GPP) Release-18 started the study on AI/ML for New Radio (NR) air interface. The goal is to explore the benefits of augmenting the air interface with features enabling improved support of AI/ML-based algorithms for enhanced performance and/or reduced complexity/overhead. Several use cases are considered to enable the identification of a common AI/ML framework, including functional requirements of AI/ML architecture, which could be used in subsequent projects. It also aims to cover the interoperability and testability aspect of the newly defined AI/ML enabled features in the communication systems.

### SUMMARY

In a first aspect of the present disclosure, there is provided a first apparatus. The first apparatus comprises at least one processor; and at least one memory storing instructions that, when executed by the at least one processor, cause the first apparatus at least to perform: transmitting test configuration information to a second apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel; receiving, from the second apparatus, at least one predicted channel indicator for the at least one TRP, the at least one predicted channel indicator being derived by the second apparatus using the AI/ML model; and determining a test result for the AI/ML model based on a comparison between the at least one predicted channel indicator and the at least one test channel indicator, the test result indicating whether the AI/ML model is validated.

In a second aspect of the present disclosure, there is provided a second apparatus. The second apparatus comprises at least one processor; and at least one memory storing instructions that, when executed by the at least one processor, cause the second apparatus at least to perform: receiving test configuration information from a first apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel; based on the test configuration information, deriving at least one predicted channel indicator for the at least one TRP using the AI/ML model; and transmitting, to the first apparatus, at least one predicted channel indicator for the at least one TRP.

In a third aspect of the present disclosure, there is provided a method. The method comprises: transmitting test configuration information to a second apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel; receiving, from the second apparatus, at least one predicted channel indicator for the at least one TRP, the at least one predicted channel indicator being derived by the second apparatus using the AI/ML model; and determining a test result for the AI/ML model based on a comparison between the at least one predicted channel indicator and the at least one test channel indicator, the test result indicating whether the AI/ML model is validated.

In a fourth aspect of the present disclosure, there is provided a method. The method comprises: receiving test configuration information from a first apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel; based on the test configuration information, deriving at least one predicted channel indicator for the at least one TRP using the AI/ML model; and transmitting, to the first apparatus, at least one predicted channel indicator for the at least one TRP.

In a fifth aspect of the present disclosure, there is provided a first apparatus. The first apparatus comprises means for transmitting test configuration information to a second apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel; means for receiving, from the second apparatus, at least one predicted channel indicator for the at least one TRP, the at least one predicted channel indicator being derived by the second apparatus using the AI/ML model; and means for determining a test result for the AI/ML model based on a comparison between the at least one predicted channel indicator and the at least one test channel indicator, the test result indicating whether the AI/ML model is validated.

In a sixth aspect of the present disclosure, there is provided a second apparatus. The second apparatus comprises means for receiving test configuration information from a first apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel; means for based on the test configuration information, deriving at least one predicted channel indicator for the at least one TRP using the AI/ML model; and means for transmitting, to the first apparatus, at least one predicted channel indicator for the at least one TRP.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a flowchart of a signaling flow for AI/ML model test in accordance with some example embodiments of the present disclosure;

FIG. 3 illustrates a flowchart of an AI/ML model test process in accordance with some example embodiments of the present disclosure;

FIG. 4A and FIG. 4B illustrate example test setups for the NLOS condition and LOS condition in accordance with some example embodiments of the present disclosure;

FIG. 5 illustrates a flowchart of a method implemented at a first apparatus in accordance with some example embodiments of the present disclosure;

FIG. 6 illustrates a flowchart of a method implemented at a second apparatus in accordance with some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “model” is referred to as an association between an input and an output learned from training data, and thus a corresponding output may be generated for a given input after the training. The generation of the model may be based on machine learning (ML) techniques. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein. Supervised learning refers to a process of training a model from input and its corresponding labels. The trained model is then used to infer the output.

Generally, model lifecycle management may usually include three stages, i.e., a training stage, a validation stage, and an application stage (also referred to as an inference stage). At the training stage, a given AI/ML model may be trained (or optimized) iteratively using a great amount of training data until the model can make inference close to desired outputs in the training or labelled dataset. During the training, a set of parameter values of the model is iteratively updated until a training objective is reached. Through the training process, the AI/ML model may be regarded as being capable of learning the association between the input and the output (also referred to an input-output mapping) from the training data. At the validation stage, a validation input is applied to the trained AI/ML model to test whether the model can provide a correct output, so as to determine the performance of the model. Generally, the validation stage may be considered as a step in a training process, or may be omitted in some cases. At the inference stage, the resulting AI/ML model may be used to process a real-world model input based on the trained model obtained from the training process and to determine the corresponding model output. In some cases, a retraining or updating stage may be included in the model lifecycle management, to enable the model evolved to have better performance.

To facilitate understanding of the terminologies, some definitions of the list of terminologies used for AI/ML are provided below.

AI/ML Model: A data driven algorithm that applies AI/ML techniques to generate a set of outputs based on a set of inputs.

AI/ML model delivery: A generic term referring to delivery of an AI/ML model from one entity to another entity in any manner. Note: An entity could mean a network node/function (e.g., gNB, location management function (LMF), etc.), UE, proprietary server, etc.

AI/ML model Inference: A process of using a trained AI/ML model to produce a set of outputs based on a set of inputs.

AI/ML model testing: A subprocess of training, to evaluate the performance of a final AI/ML model using a dataset different from one used for model training and validation. Differently from AI/ML model validation, testing does not assume subsequent tuning of the model.

AI/ML model training: A process to train an AI/ML Model [by learning the input/output relationship] in a data driven manner and obtain the trained AI/ML Model for inference.

AI/ML model transfer: Delivery of an AI/ML model over the air interface in a manner that is not transparent to 3GPP signalling, either parameters of a model structure known at the receiving end or a new model with parameters. Delivery may contain a full model or a partial model.

AI/ML model validation: A subprocess of training, to evaluate the quality of an AI/ML model using a dataset different from one used for model training, that helps selecting model parameters that generalize beyond the dataset used for model training.

Data collection: A process of collecting data by the network nodes, management entity, or UE for the purpose of AI/ML model training, data analytics and inference.

Federated learning/federated training: A machine learning technique that trains an AI/ML model across multiple decentralized edge nodes (e.g., UEs, gNBs) each performing local model training using local data samples. The technique requires multiple interactions of the model, but no exchange of local data samples.

Functionality identification: A process/method of identifying an AI/ML functionality for the common understanding between the network and the UE. Note: Information regarding the AI/ML functionality may be shared during functionality identification. Where AI/ML functionality resides depends on the specific use cases and sub use cases.

Model activation: enable an AI/ML model for a specific function.

Model deactivation: disable an AI/ML model for a specific function.

Model download: Model transfer from the network to UE.

Model identification: A process/method of identifying an AI/ML model for the common understanding between the network (NW) and the UE. Note: The process/method of model identification may or may not be applicable. Note: Information regarding the AI/ML model may be shared during model identification.

Model monitoring: A procedure that monitors the inference performance of the AI/ML model.

Model parameter update: Process of updating the model parameters of a model.

Model selection: The process of selecting an AI/ML model for activation among multiple models for the same AI/ML enabled feature. Note: Model selection may or may not be carried out simultaneously with model activation.

Model switching: Deactivating a currently active AI/ML model and activating a different AI/ML model for a specific function.

Model update: Process of updating the model parameters and/or model structure of a model.

Model upload: Model transfer from UE to the network.

Network-side (AI/ML) model: An AI/ML Model whose inference is performed entirely at the network.

Offline field data: The data collected from field and used for offline training of the AI/ML model.

Offline training: An AI/ML training process where the model is trained based on collected dataset, and where the trained model is later used or delivered for inference. Note: This definition only serves as a guidance. There may be cases that may not exactly conform to this definition but could still be categorized as offline training by commonly accepted conventions.

Online field data: The data collected from field and used for online training of the AI/ML model.

Online training: An AI/ML training process where the model being used for inference) is (typically continuously) trained in (near) real-time with the arrival of new training samples. Note: the notion of (near) real-time vs. non real-time is context-dependent and is relative to the inference time-scale. Note: This definition only serves as a guidance. There may be cases that may not exactly conform to this definition but could still be categorized as online training by commonly accepted conventions. Note: Fine-tuning/re-training may be done via online or offline training. (This note could be removed when we define the term fine-tuning.)

Reinforcement Learning (RL): A process of training an AI/ML model from input (a.k.a. state) and a feedback signal (a.k.a. reward) resulting from the model's output (a.k.a. action) in an environment the model is interacting with.

Semi-supervised learning: A process of training a model with a mix of labelled data and unlabelled data.

Two-sided (AI/ML) model: A paired AI/ML Model(s) over which joint inference is performed, where joint inference comprises AI/ML Inference whose inference is performed jointly across the UE and the network, i.e, the first part of inference is firstly performed by UE and then the remaining part is performed by the gNB, or vice versa.

UE-side (AI/ML) model: An AI/ML Model whose inference is performed entirely at the UE.

Unsupervised learning: A process of training a model without labelled data.

Proprietary-format models: ML models of vendor-/device-specific proprietary format, from 3GPP perspective. They are not mutually recognizable across vendors and hide model design information from other vendors when shared. Note: An example is a device-specific binary executable format.

Open-format models: ML models of specified format that are mutually recognizable across vendors and allow interoperability, from the 3GPP perspective. They are mutually recognizable between vendors and do not hide model design information from other vendors when shared.

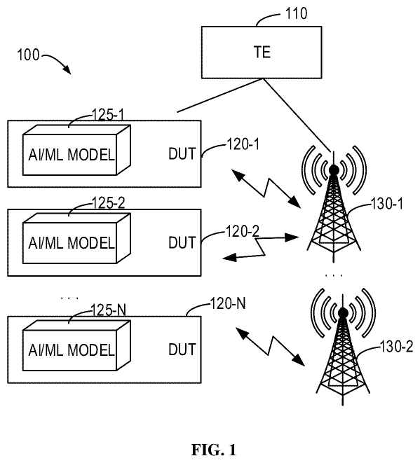

FIG. 1 illustrates an example communication environment 100 in which example embodiments of the present disclosure can be implemented. It is to be understood that the elements shown in the communication system 100 are intended to represent main functions provided within the system. As such, the blocks shown in FIG. 1 refer to specific elements in communication networks that provide these main functions. However, other network elements may be used to implement some or all of the main functions represented. Also, it is to be understood that not all functions of a communication network are depicted in FIG. 1. Rather, functions that facilitate an explanation of illustrative embodiments are represented. Further, the number of the elements shown in FIG. 1 is also for the purpose of illustration only and there may be any number of elements.

As shown, the communication environment 100 comprises a plurality of communication devices, including testing equipment (TE) 110, one or more devices under test (DUTs) 120-1, 120-2, . . . , 120-N(collectively or individually referred to as DUTs 120) and one or more TRPs 130-1, 130-2 (collectively or individually referred to as TRPs 130). A serving area of the TRP 130 may be called a cell. The DUTs 120 may perform signal transmission and reception with the TRPs 130.

In some example embodiments, one or more AI/ML models 125-1, 125-2, . . . , 125-N(collectively or individually referred to as AI/ML models 125) may be used by the one or more DUTs 120. An AI/ML model 125 may sometimes be referred to as an AI model or an ML model for short. Different AI/ML models 125 may be configured to implement the same different algorithms in the communication environment 100. The AI/ML model 125 used by a DUT 120 may sometimes include to either a model or an AI/ML functionality.

In some example embodiments, the AI/ML models 125 are configured for AI/ML based positioning or AI/ML enabled positioning. AI/ML enabled positioning is one of the selected use-cases for the study item in the development of communication networks. In some example embodiments, there have been proposed two positioning approaches. A first approach is direct AI/ML positioning where the output of the AI/ML model inference is the UE location. There are multiple options for the input of the model which includes, channel observations such as Channel Impulse Response (CIR), Power Delay Profile (PDP), Reference Signal Received Power (RSRP), Reference Signal Received Path Power (RSRPP), etc. A second approach is AIML assisted positioning where the output of the AI/ML model inference is a new measurement and/or enhancement to the existing measurements, and such new measurement and/or enhancement may be called as intermediate feature as it will be input to a second function to finally estimate the UE position. These measurements include, e.g., line-of-sight (LOS)/non-line-of-sight (NLOS) identifications, Time of Arrival (ToA), path phase, Reference Signal Time Difference (RSTD), etc.

In some example embodiments of the present disclosure, TE 110 is configured to test the AI/ML model(s) 125 used by the DUTs 120. In some example embodiments, TE 110 may be a network entity in the core network, a base station (e.g., gNB, eNB) in RAN, or may be a terminal device (e.g., UE) or any other device that is configured for AI/ML testing.

In some example embodiments, a DUT 120 may be a terminal device (e.g., UE) that uses the AI/ML model 125 for positioning purpose. In some example embodiments, a DUT 120 may also be a network entity in the core network or a base station (e.g., gNB, eNB) in RAN which is configured to uses the AI/ML model 125 for positioning purpose.

Study and provide inputs on benefit(s) and potential specification impact at least for the following cases of AI/ML based positioning accuracy enhancement:
Case 1: UE-based positioning with UE-side model, direct AI/ML or AI/ML assisted positioning;
Case 2a: UE-assisted/LMF-based positioning with UE-side model, AI/ML assisted positioning;
Case 2b: UE-assisted/LMF-based positioning with LMF-side model, direct AI/ML positioning;
Case 3a: NG-RAN node assisted positioning with gNB-side model, AI/ML assisted positioning;
Case 3b: NG-RAN node assisted positioning with LMF-side model, direct AI/ML positioning.

As can be seen in the above agreement, in some example embodiments, for UE based positioning, AI/ML model inference may include a LOS/NLOS indicator. The LOS/NLOS inference may be based on reference signal measurements, such as positioning reference signals (PRS) based measurements. In some example embodiments, PRS is transmitted by the transmission and reception points (TRPs) in the network.

In communication networks, there are test mechanisms defined for location estimation and latency for Global Navigation Satellite System (GNSS) based positioning. These test mechanisms are defined for various satellites and relies on the GNSS measurements. However, there are no test mechanisms defined for verifying the LOS/NLOS feature of the terminal device. The AI/ML models may be provisioned for use at the terminal devices in any ways. It is desired to provide test mechanisms to validate the inference of the AI/ML models.

For UE-based AI/ML positioning, LOS/NLOS is selected as an intermediate test metric or key performance indicator (KPI) for performance evaluation of inference. In some cases, it is expected that the terminal vendors would not disclose the details of their AI/ML models deployed at the terminal side for the positioning purpose, which could be part of their proprietary algorithm (e.g., black box). The network would not have knowledge about the UE-based AI/ML model, including its accuracy or performance in terms of positioning. However, network would want to monitor the performance KPIs of the AI/ML model, to initiate lifecycle management (LCM) based procedures (e.g., model reselection, update, switching, deactivation, etc.)

Currently, the requirements on positioning in communication networks assume that UE is reporting measurements (e.g., RSRPP measurements, etc.) and then the UE position is determined in the LMF. Therefore, the legacy requirements and tests are formulated not on the actual position but on the accuracy and latency of measurements performed and reported by the UE. In the case of UE based positioning or UE assisted positioning, there may be intermediate features such as LOS/NLOS indication that may be used as input for deriving the location coordinates either at the UE or at the network side (e.g., gNB or LMF). Thus, the legacy requirements cannot be applied for the intermediate KPIs, and no requirements and tests are defined to verify the UE-based positioning functionalities, e.g., LOS/NLOS evaluation.

Some of legacy positioning techniques (such as Assisted GNSS (A-GNSS)) have performance requirements on location estimation and latency for GNSS based positioning. However, there are no test mechanisms defined for verifying the LOS/NLOS inference as the intermediate feature of the UE for PRS (Positioning reference signals) based measurements. The LOS/NLOS indication can be the result of inference of the AI/ML model for the TRP which can be used as input to an AI/ML based or non-AI/ML based algorithm at the UE or at the network (e.g., gNB, and/or LMF) to derive the location co-ordinates. PRSs are transmitted by multiple TRPs (Transmission and Reception Point) in the network for allow the UEs to perform positioning measurements.

One of the main challenges in testing LOS/NLOS inference of the UE-based AI/ML model is that there is no defined procedure for verification of the inference results with the ground truth. Ground truth is the actual information that indicates whether the UE is receiving the PRS signal directly from the TRP (i.e., a LOS condition) or whether the PRS signal is received indirectly via a multipath (i.e., the reflected signals are received by the UE, which is also called as a NLOS condition).

Hence, there is a need for defining a test mechanism for verification of the LOS/NLOS inference for the use case of AI/ML based positioning.

According to example embodiments of the present disclosure, there is proposed a solution for validating and testing UE-based or UE-assisted AI/ML positioning. It is assumed that an AI/ML model is used at a terminal side for deriving LOS/NLOS inference. The testing of such an AI/ML model relies on reference signal transmissions from the network, e.g., from one or more TRPs. In addition, the one or more TRPs are controlled to be arranged according to a test plan with one or more selected test channel indicators (also referred to as reference channel indicators or ground-truth channel indicators). A channel indicator indicates a LOS condition or a NLOS condition between a device to be tested and a corresponding TRP. The device to be tested is configured in a test mode for the AI/ML model and thus can report one or more predicted channel indicators for the one or more TRPs. By comparing the selected test channel indicators with the predicted channel indicators reported by the device to be tested, a test result of the AI/ML model can be obtained, to determine whether the AI/ML model is validated or not.

Example embodiments of the present disclosure will be described in detail below with reference to the accompanying drawings.

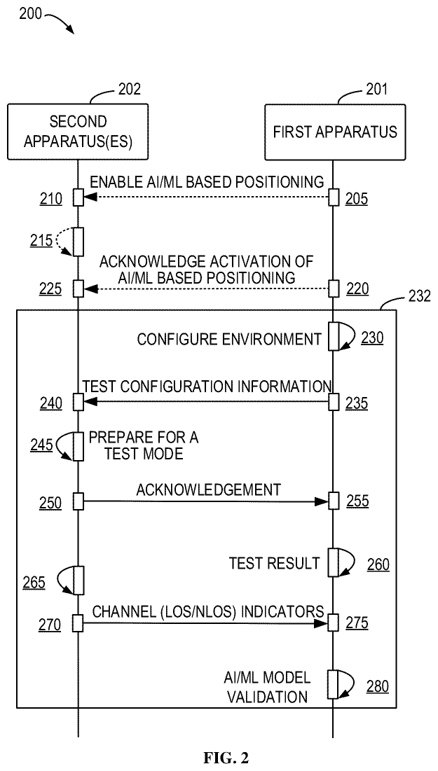

FIG. 2 illustrates a flowchart of a signaling flow 200 for AI/ML model test in accordance with some example embodiments of the present disclosure. As shown in FIG. 2, the signaling flow 200 involves a first apparatus 201 and a set of second apparatuses 202 (including one or more second apparatuses).

The first apparatus 201 may be referred to as a TE, e.g., the TE 110 in the environment 100 of FIG. 1. The first apparatus 201 is configured to emulate/simulate a real wireless network. In some example embodiment, the first apparatus 201 may be a real network device (e.g., gNB) or may be a system simulator, operating as signal generators, probes, or transmission points that are used to transmit radio signal of certain type (e.g., used for SSB transmission). In some example embodiments, the first apparatus 201 may also include channel emulators and/or attenuators to emulate the propagation of the radio signal. The different propagations conditions allow to set up different LOS/NLOS conditions. As will be discussed below, reference LOS/NLOS probabilities can be selected for the test setup.

The one or more second apparatuses 202 may comprise DUTs in the environment 100 of FIG. 1, which may be one or more of terminal devices, network entities, or base stations. In embodiments of the present disclosure, a second apparatus 202 may be able to implement AI/ML assisted positioning. An AI/ML model is utilized by the second apparatus 202 to implement the AI/ML assisted positioning. The output of the AI/ML model is a channel indicator for a communication channel between the second apparatus 202 and a network device, e.g., a TRP or base station. The channel indicator indicates a probability of a communication channel between the second apparatus 202 and the TRP being a LOS channel or a NOLS channel. Such a channel indicator may also be referred to as a LOS/NLOS indicator. The input to the AI/ML model may include measurement results of one or more reference signals transmitted from the TRP.

In example embodiments of the present disclosure, a second apparatus 202 may be tested in a certain environment (which is also referred to as a test environment or a test area). This environment is the area where the test of the AI/ML model is performed. In some example embodiments, the environment may be an anechoic chamber or a larger/outdoor area with a number of TRPs having LOS transmission towards the second apparatus 202 and a number of TRPs having NLOS transmission towards the second apparatus 202 (i.e., via reflectors/obstacles).

In the signaling flow 200, the second apparatus 202 and the first apparatus(es) 201 perform a test procedure 232 to validate inference of the AI/ML model(s) at the side of the first apparatus(es) 201. In some example embodiments, the test procedure 232 may be performed in an iterative way depending on the actual requirements. In the following, operations at a second apparatus 202 are described and other second apparatuses may perform similar operations.

In some example embodiments, to enable the AI/ML model test, the first apparatus 201 may transmit (205) a command to a second apparatus 202 to enable AI/ML-based or AI/ML-assisted positioning at the second apparatus 202. Upon receiving (210) the command, the second apparatus 202 may enable (215) the AI/ML-based or AI/ML-assisted positioning for positioning measurement. The second apparatus 202 may transmit (220) acknowledgement of activation of the AI/ML-based or AI/ML-assisted positioning to the first apparatus 201. Based on receiving (225) the acknowledgement, the first apparatus 201 may determine to activate the test procedure 232. It would be appreciated that in some other example embodiments, the activation of the AI/ML-based or AI/ML-assisted positioning at the second apparatus 202 may be triggered by other network devices.

During the test procedure 232, the first apparatus 201 configures (230) an environment for testing an AI/ML model at a second apparatus 202 and transmits (235) test configuration information to the second apparatus 202. The test configuration information indicates a test mode of an AI/ML model with respect to at least one TRP. The at least one TRP is arranged within the environment based on a test plan for at least one test channel indicator. A test channel indicator indicates a (reference) probability of a communication channel between the second apparatus and a TRP being a LOS channel or a NLOS channel.

In some example embodiments, the test configuration information may be communicated via the air interface to the second apparatus 202. In some example embodiments, the test configuration information may be communicated as an application layer level command.

The second apparatus 202 receives (240) the test configuration information from the first apparatus 201 and prepares (245) for the test mode for the AI/ML model. In some example embodiments, the second apparatus 202 may transmit (250) acknowledgement of the test configuration information to the first apparatus 201. Based on receiving (255) the acknowledgement of the test configuration information, the first apparatus 201 may cause (260) the test plan to be executed. In some example embodiments, the acknowledgement of the test configuration information may be communicated via the air interface to the first apparatus 201. In some example embodiments, the acknowledgement of the test configuration information may be communicated as an application layer level command.

For any AI/ML model deriving LOS/NLOS inference, the LOS/NLOS inference needs to be tested and validated against the labelled data in order to increase the confidence on the training data and the model output. The “labels” refers to trusted model inference and are also represented as the ground truth. In the case of LOS/NLOS inference, the labels include the trusted LOS/NLOS indication between the second apparatus 202 and the at least one TRP. To configure the labels, the environment for testing the AI/ML model used by the second apparatus 202 may be specifically defined.

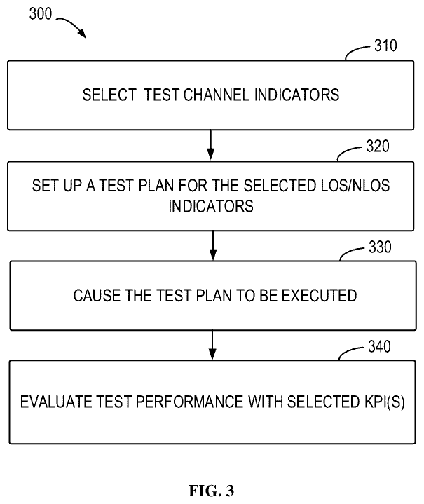

FIG. 3 illustrates a flowchart of an AI/ML model test process 300 in accordance with some example embodiments of the present disclosure. At block 310, the first apparatus 201 selects the at least one test channel indicator for the at least one TRP. As mentioned, a test channel indicator may indicate a probability of a communication channel between the second apparatus 202 and a TRP being a LOS channel or a NLOS channel, and such a probability may also be referred to as a reference LOS/NLOS probability.

In some example embodiments, the first apparatus 201 may select the reference LOS/NLOS probability to be tested. In some examples, the selection of the reference LOS/NLOS probability may correspond to an interval with a step size. For example, with regard to a given TRP, the first apparatus 201 may select the reference probability from a NLOS probability range of [0%-100%], with 10% steps. That is, the first apparatus 201 may select one or more of the values {0%, 10%, . . . , 90%, 100%} of LOS probability, which is complimentary to a LOS probability (for example, 10% of NLOS probability corresponds to 90% of LOS probability). It would be appreciated that the selection of the step or reference values can be carried out in accordance with the desired AI/ML model accuracy. In addition, in case of multiple TRPs, the reference LOS/NLOS probability may be provided per TRP basis. In some example embodiments, in the test setup, a TRP may be either a real base station or may be emulated, or it can be a combination of both.

At block 320, the first apparatus 202 sets up the test plan based on the at least one selected test channel indicator. The test plan may comprise a test setup for a test channel indicator, a test setup being defined as a physical arrangement of a TRP with respect to the second apparatus 202 and one or multiple signal reflectors or obstacle(s) within the environment.

For each value of the reference LOS/NLOS probability, a dedicated test setup may be defined with the required configuration (e.g., with the needed signal reflectors or obstacles) to reach the desired LOS/NLOS probability to test each time.

For example, for a LOS condition, a test setup for a test channel indicator may be defined to indicate a probability of a communication channel between the second apparatus 202 and a TRP being a LOS channel. This test setup may be defined as a physical arrangement of the TRP towards the second apparatus 202. For a NLOS condition, a test setup for a test channel indicator may be defined to indicate a probability of a communication channel between the second apparatus 202 and a TRP being a NLOS channel. This test setup may be defined as a physical arrangement of the TRP towards at least one signal reflector, such that reference signals transmitted from the TRP may be reflected to the second apparatus 202.

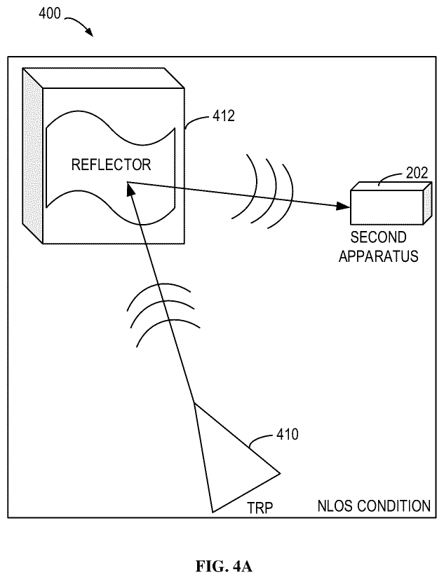

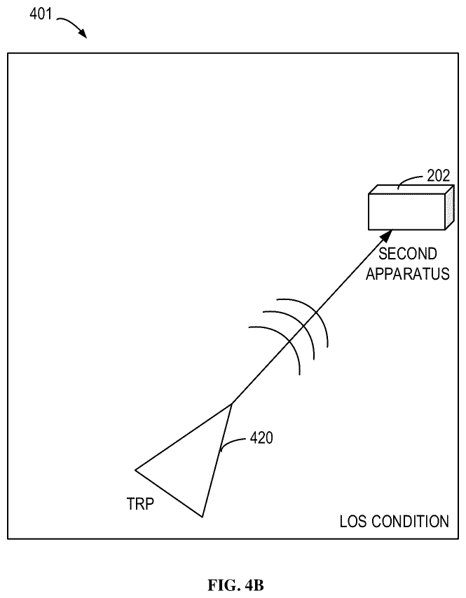

FIG. 4A and FIG. 4B illustrate example test setups for the NLOS condition 400 and LOS condition 401 in accordance with some example embodiments of the present disclosure. In the NLOS condition 400, one or more signal reflectors 412 may be arranged to reflect the signals transmitted from a TRP 410 to the second apparatus 202, so as to re-create a multipath scenario (i.e., the NLOS case). The TRP 410 may be arranged towards the signal reflectors 412. The test setup may require the signal reflector(s) to be placed in different location(s) so as to reflect the signals received from a TRP towards the second apparatus 202 based on the desired selected LOS/NLOS probability for the TRP. In the LOS condition 401, a TRP 420 may be arranged towards to the second apparatus 202, to create a direct signal propagation path.

Based on the test plan, there may be a first number of (“n”) TRPs that are arranged to be directed towards the second apparatus 202 to emulate the LOS scenario and there may be a second number of (“m”, where m may or may not be equal to n) TRPs that are arranged to be directed towards the signal reflector(s) so that the reflected signals are received by the second apparatus 202 to emulate the NLOS scenario with the desired reference LOS/NLOS probabilities as indicated in block 310 of FIG. 3. In some example embodiments, for TRPs directed towards the reflectors, it should be ensured that the transmitted reference signals can reach the second apparatus 202 based on the corresponding reference LOS/NLOS probabilities.

The first apparatus 201 may configure the test environment according to the test setups in the test plan, for example, to cause the at least one TRP and the signal reflectors (or obstacles) to be arranged in the environment according to the at least one test channel indicator. As indicated above, the first apparatus 201 may further transmit the test configuration information to the second apparatus 202 to trigger the test mode of the AI/ML model.

The first apparatus 201 may configure the second apparatus 202 with the required configuration including the AI/ML model whose LOS/NLOS inference is to be tested. The first apparatus 201 may also configure the second apparatus 202 with the test mode to indicate the second apparatus 202 to report the AI/ML model inference for all the configured TRPs.

In some example embodiments, the test configuration information may comprise an indication of the AI/ML model to be tested, and/or an indication of the at least one TRP involved in the test mode. The indicated TRP(s) may be those that are configured in the environment according to the test plan. In some example embodiments, the test configuration information may comprise an indication of the test mode, a test command, or a test configuration for the AI/ML model. For example, the second apparatus 202 may be preconfigured with the AI/ML model to be tested and/or the TRP(s) involved for testing the AI/ML model. By indicating the test mode, the test command, or the test configuration, the second apparatus 202 can prepare to send the predicted channel indicator(s) to the first apparatus 201.

At block 330 of the process 300, the first apparatus 201 causes the test plan to be executed. In the execution of the test plan, the different reference LOS/NLOS probabilities may be used iteratively to test the AI/ML model at the second apparatus, e.g., by arranging the TRP(s) and other required reflectors/obstacles in the environment each time and causing the TRP(s) to transmit the reference signals for channel measurements. At block 340, the first apparatus 201 evaluates the test performance over the different iterations on the reference LOS/NLOS probabilities through selected KPI(s). The KPI used for model performance evaluation may include, for example, 90% percentile of cumulative distribution function (CDF) value on the error between the ground truth/reference LOS/NLOS probabilities and the inference result provided from the second apparatus 202.

In some example embodiments, after the test environment are configured and after the second apparatus 202 to be tested have acknowledged reception of the test configuration information, the first apparatus 201 may cause the at least one TRP arranged within the environment to transmit reference signals. Then the second apparatus 202 may measure the reference signals and provide the measurement results as inputs to the AI/ML model to derive the LOS/NLOS indicators. Correspondingly, the second apparatus 202 may collect the measurement results of the reference signals from the TRP(s) and provide the measurement results as the input to the AI/ML model. The AI/ML model can be run to derive a predicted channel indicator, indicating a predicted LOS/NLOS probability for the corresponding TRP(s).

Referring back to FIG. 2, in the signaling flow 200, as the test plan is executed, the second apparatus 202 derives (265) at least one predicted channel indicator for the at least one TRP using the AI/ML model. Specifically, as the test plan is executed, the at least one TRP arranged in the environment may transmit reference signals. The second apparatus 202 may detect measurement results of the reference signals from a TRP and input the measurement results to the AI/ML model to derive the channel indicator for the corresponding TRP. It would be appreciated that depending on the AI/ML model configuration, various types of measurement results may be collected as inputs to the AI/ML model to determine whether a channel between the second apparatus 202 and the corresponding TPR is a LOS channel or a NLOS channel. The scope of the present disclosure is not limited in this regard.

The second apparatus 202 transmits (270), to the first apparatus 201, at least one predicted channel indicator for the configured at least one TRP. A predicted channel indicator indicates the probability of the channel between second apparatus 202 and the corresponding TPR being a LOS channel or a NLOS channel as derived by the used AI/ML model.

The first apparatus 201 receives (275) the at least one predicted channel indicator from the second apparatus 202 and determines (280) a test result for the AI/ML model based on a comparison between the at least one predicted channel indicator and the at least one test channel indicator. The test result can indicate whether the AI/ML model is validated.

In some example embodiments, the first apparatus 201 may compare the received predicted channel indicator (e.g., the LOS/NLOS probability) for each TRP with the test channel indicator (e.g., the configured LOS/NLOS probability). In some example embodiments, the first apparatus 201 may display the comparison result in form of table or graph. In some example embodiments, the comparison result may also be used as input to an AI/ML model for calibration.

In some example embodiments, if the at least one predicted channel indicator matches with the at least one test channel indicator, the first apparatus 201 may determine the test result to indicate that the AI/ML model is validated. If the at least one predicted channel indicator mismatches with the at least one test channel indicator, the first apparatus 201 may determine the test result to indicate that the AI/ML model is invalidated. For example, if the inference values for all the configured TRPs match with the configured reference values (i.e., LOS or NLOS probabilities), for example, if the inference values match with the configured reference values for a predetermined number of samples, the test may be considered as validated successfully and the first apparatus 201 may declare the test of the AI/ML model as “PASSED”. Else, the test may be considered as validation failed, and the first apparatus 201 may declare the test of the AI/ML model as “FAILED”.

According to the example embodiments of the present disclosure as discussed above, a test mechanism is provided for validating the LOS/NLOS inference in the AI/ML-based positioning or AI/ML-assisted positioning is provided. With this test mechanism, the LOS/NLOS inference at the terminal side can be verified, to avoid introducing unqualified intermediate results in the AI/ML positioning use case.

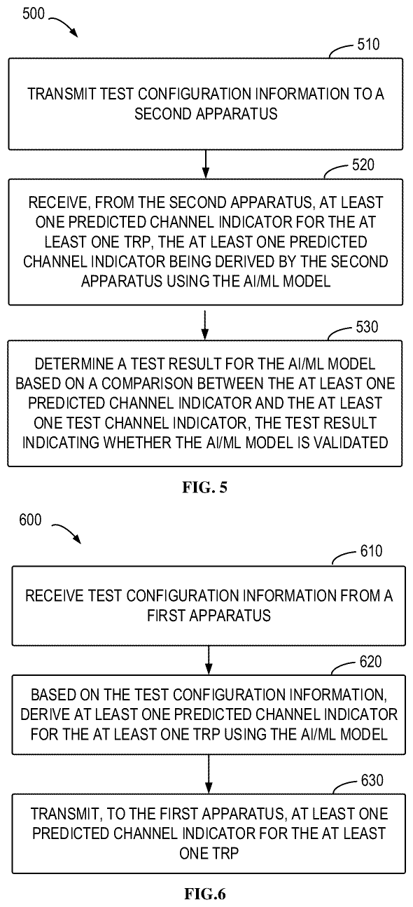

FIG. 5 shows a flowchart of an example method 500 implemented at a second apparatus in accordance with some example embodiments of the present disclosure. For the purpose of discussion, the method 500 will be described from the perspective of the first apparatus 201 in FIG. 2 (which may be TE 110 in FIG. 1).

At block 510, the first apparatus 201 transmits test configuration information to a second apparatus (the second apparatus 202 in FIG. 2 or the DUT 201 in FIG. 1), the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel.

At block 520, the first apparatus 201 receives, from the second apparatus, at least one predicted channel indicator for the at least one TRP, the at least one predicted channel indicator being derived by the second apparatus using the AI/ML model.

At block 530, the first apparatus 201 determines a test result for the AI/ML model based on a comparison between the at least one predicted channel indicator and the at least one test channel indicator, the test result indicating whether the AI/ML model is validated.

In some example embodiments, the test configuration information comprises at least one of the following: an indication of the AI/ML model to be tested, an indication of the at least one TRP, or an indication of the test mode, a test command, or a test configuration.

In some example embodiments, the first apparatus 201 may further select the at least one test channel indicator for the at least one TRP; and determine the test plan based on the at least one test channel indicator, the test plan comprising a test setup for a test channel indicator, a test setup being defined as a physical arrangement of a TRP with respect to the second apparatus and at least one signal reflector within the environment; and causing the at least one TRP to be arranged according to the test plan.

In some example embodiments, the test plan comprises: a first test setup for a test channel indicator indicating a probability of a communication channel between the second apparatus and a first TRP being a line-of-sight channel, the first test setup being defined as a physical arrangement of the first TRP towards the second apparatus, and a second test setup for a test channel indicator indicating a probability of a communication channel between the second apparatus and a second TRP being a non-line-of-sight channel, the second test setup being defined as a physical arrangement of the second TRP towards at least one signal reflector.

In some example embodiments, the first apparatus 201 may further cause the at least one TRP arranged within the environment to transmit reference signals, measurement results of the reference signals being measured by the second apparatus and used as inputs to the AI/ML model.

In some example embodiments, the first apparatus 201 may receive, from the second apparatus, acknowledgement of the test configuration information; and based on receiving the acknowledgement of the test configuration information, cause the test plan to be executed.

In some example embodiments, based on a determination that the at least one predicted channel indicator matches with the at least one test channel indicator, the first apparatus 201 may determine the test result to indicate that the AI/ML model is validated; and based on a determination that the at least one predicted channel indicator mismatches with the at least one test channel indicator, the first apparatus 201 may determine the test result to indicate that the AI/ML model is invalidated.

In some example embodiments, the first apparatus 201 comprises testing equipment, and the second apparatus comprises a device under test.

In some example embodiments, the testing equipment comprises a network entity, a base station, or a terminal device, and wherein the device under test comprises a network entity, a base station, or a terminal device, wherein the terminal device comprises one or more receivers.

FIG. 6 shows a flowchart of an example method 600 implemented at a third apparatus in accordance with some example embodiments of the present disclosure. For the purpose of discussion, the method 600 will be described from the perspective of the second apparatus 202 in FIG. 2 (which may be a DUT 120 in FIG. 1).

At block 610, the second apparatus 202 receives test configuration information from a first apparatus (e.g., the first apparatus 201 in FIG. 1 or TE 110 in FIG. 1), the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel.

At block 620, based on the test configuration information, the second apparatus 202 derives at least one predicted channel indicator for the at least one TRP using the AI/ML model.

At block 630, the second apparatus 202 transmits to the first apparatus at least one predicted channel indicator for the at least one TRP.

In some example embodiments, the test configuration information comprises at least one of the following: an indication of the AI/ML model to be tested, an indication of the at least one TRP, or an indication of the test mode, a test command, or a test configuration.

In some example embodiments, the second apparatus 202 may further transmit, to the first apparatus, acknowledgement of the test configuration information, to trigger the test plan to be executed.

In some example embodiments the second apparatus 202 may further measure reference signals transmitted from the at least one TRP; and providing the measurement results of reference signals as inputs to the AI/ML model to derive the at least one predicted channel indicator.

In some example embodiments, the first apparatus comprises testing equipment, and the second apparatus comprises a device under test.

In some example embodiments, the testing equipment comprises a network entity, a base station, or a terminal device, and wherein the device under test comprises a network entity, a base station, or a terminal device, wherein the terminal device comprises one or more receivers.

In some example embodiments, a first apparatus capable of performing any step of the method 400 (for example, the first apparatus 201 in FIG. 2) may comprise means for performing the respective operations of the method 500. The means may be implemented in any suitable form. For example, the means may be implemented in a circuitry or software module. The first apparatus may be implemented as or included in the first apparatus 201 in FIG. 2.

In some example embodiments, the first apparatus comprises means for transmitting test configuration information to a second apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel; means for receiving, from the second apparatus, at least one predicted channel indicator for the at least one TRP, the at least one predicted channel indicator being derived by the second apparatus using the AI/ML model; and means for determining a test result for the AI/ML model based on a comparison between the at least one predicted channel indicator and the at least one test channel indicator, the test result indicating whether the AI/ML model is validated.

In some example embodiments, the test configuration information comprises at least one of the following: an indication of the AI/ML model to be tested, an indication of the at least one TRP, or an indication of the test mode, a test command, or a test configuration.

In some example embodiments, the first apparatus further comprises: means for selecting the at least one test channel indicator for the at least one TRP; means for determining the test plan based on the at least one test channel indicator, the test plan comprising a test setup for a test channel indicator, a test setup being defined as a physical arrangement of a TRP with respect to the second apparatus and at least one signal reflector within the environment; and means for causing the at least one TRP to be arranged according to the test plan.

In some example embodiments, the test plan comprises: a first test setup for a test channel indicator indicating a probability of a communication channel between the second apparatus and a first TRP being a line-of-sight channel, the first test setup being defined as a physical arrangement of the first TRP towards the second apparatus, and a second test setup for a test channel indicator indicating a probability of a communication channel between the second apparatus and a second TRP being a non-line-of-sight channel, the second test setup being defined as a physical arrangement of the second TRP towards at least one signal reflector.

In some example embodiments, the first apparatus further comprises: means for causing the at least one TRP arranged within the environment to transmit reference signals, measurement results of the reference signals being measured by the second apparatus and used as inputs to the AI/ML model.

In some example embodiments, the first apparatus further comprises: means for receiving, from the second apparatus, acknowledgement of the test configuration information; and means for, based on receiving the acknowledgement of the test configuration information, causing the test plan to be executed.

In some example embodiments, the means for determining the test result comprises: means for, based on a determination that the at least one predicted channel indicator matches with the at least one test channel indicator, determining the test result to indicate that the AI/ML model is validated; and means for, based on a determination that the at least one predicted channel indicator mismatches with the at least one test channel indicator, determining the test result to indicate that the AI/ML model is invalidated.

In some example embodiments, the first apparatus comprises testing equipment, and the second apparatus comprises a device under test.

In some example embodiments, the testing equipment comprises a network entity, a base station, or a terminal device, and wherein the device under test comprises a network entity, a base station, or a terminal device, wherein the terminal device comprises one or more receivers.

In some example embodiments, the first apparatus further comprises means for performing other operations in some example embodiments of the method 500 or the first apparatus 201. In some example embodiments, the means comprises at least one processor; and at least one memory storing instructions that, when executed by the at least one processor, cause the performance of the first apparatus.

In some example embodiments, a second apparatus capable of performing any step of the method 600 (for example, the second apparatus 202 in FIG. 2) may comprise means for performing the respective operations of the method 600. The means may be implemented in any suitable form. For example, the means may be implemented in a circuitry or software module. The second apparatus may be implemented as or included in the second apparatus 202 in FIG. 2.

In some example embodiments, the second apparatus comprises means for means for receiving test configuration information from a first apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel; means for, based on the test configuration information, deriving at least one predicted channel indicator for the at least one TRP using the AI/ML model; and means for transmitting, to the first apparatus, at least one predicted channel indicator for the at least one TRP.

In some example embodiments, the test configuration information comprises at least one of the following: an indication of the AI/ML model to be tested, an indication of the at least one TRP, or an indication of the test mode, a test command, or a test configuration.

In some example embodiments, the second apparatus further comprises: means for transmitting, to the first apparatus, acknowledgement of the test configuration information, to trigger the test plan to be executed.

In some example embodiments, the second apparatus further comprises: means for measuring reference signals transmitted from the at least one TRP; and means for providing the measurement results of reference signals as inputs to the AI/ML model to derive the at least one predicted channel indicator.

In some example embodiments, the first apparatus comprises testing equipment, and the second apparatus comprises a device under test.

In some example embodiments, the testing equipment comprises a network entity, a base station, or a terminal device, and wherein the device under test comprises a network entity, a base station, or a terminal device, wherein the terminal device comprises one or more receivers.

In some example embodiments, the second apparatus further comprises means for performing other operations in some example embodiments of the method 600 or the second apparatus 202. In some example embodiments, the means comprises at least one processor; and at least one memory storing instructions that, when executed by the at least one processor, cause the performance of the second apparatus.

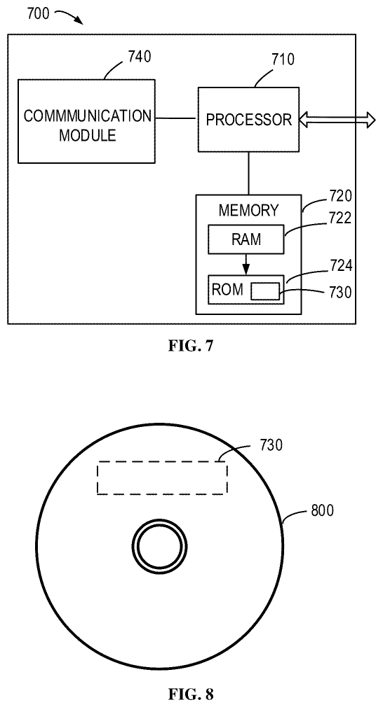

FIG. 7 is a simplified block diagram of a device 700 that is suitable for implementing example embodiments of the present disclosure. The device 700 may be provided to implement a communication device, for example, the DUT 120, TE 110 or the TRP 130 as shown in FIG. 1, or the first apparatus 201 or the second apparatus 202 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any of the processes in the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any step of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an crasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Some abbreviations used in the present disclosure are provided below with their representation in un-shortened form. It is noted that widely established and unique abbreviations can be assumed as known.

### LIST OF ABBREVIATIONS

AI-Artificial Intelligence
ML-Machine Learning
3GPP-3rd Generation Partnership Project
KPI-Key Performance Indicator
PRS-Positioning Reference Signal
RSRP-Reference Signal Received Power
RSTD-Reference Signal Time Difference
LOS-Line Of Sight
NLOS-Non-Line Of Sight
A-GNSS-Assisted Global Navigation Satellite System
TRP-Transmission and Reception Point
UE-User Equipment
DUT-Device Under Test
TE-Testing Equipment
SSB-Synchronization Signal/PBCH Block
PBCH-Physical Broadcast Channel

What is claimed is:

1. A first apparatus comprising:
at least one processor; and
at least one memory storing instructions that, when executed by the at least one processor, cause the first apparatus at least to perform:
transmitting test configuration information to a second apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel;
receiving, from the second apparatus, at least one predicted channel indicator for the at least one TRP, the at least one predicted channel indicator being derived by the second apparatus using the AI/ML model; and
determining a test result for the AI/ML model based on a comparison between the at least one predicted channel indicator and the at least one test channel indicator, the test result indicating whether the AI/ML model is validated.

2. The apparatus of claim 1, wherein the test configuration information comprises at least one of the following:
an indication of the AI/ML model to be tested,
an indication of the at least one TRP, or
an indication of the test mode, a test command, or a test configuration.

3. The apparatus of claim 1, wherein the first apparatus is further caused to perform:
selecting the at least one test channel indicator for the at least one TRP;
determining the test plan based on the at least one test channel indicator, the test plan comprising a test setup for a test channel indicator, a test setup being defined as a physical arrangement of a TRP with respect to the second apparatus and at least one signal reflector within the environment; and
causing the at least one TRP to be arranged according to the test plan.

4. The apparatus of claim 3, wherein the test plan comprises:
a first test setup for a test channel indicator indicating a probability of a communication channel between the second apparatus and a first TRP being a line-of-sight channel, the first test setup being defined as a physical arrangement of the first TRP towards the second apparatus, and
a second test setup for a test channel indicator indicating a probability of a communication channel between the second apparatus and a second TRP being a non-line-of-sight channel, the second test setup being defined as a physical arrangement of the second TRP towards at least one signal reflector.

5. The apparatus of claim 1, wherein the first apparatus is further caused to perform:
causing the at least one TRP arranged within the environment to transmit reference signals, measurement results of the reference signals being measured by the second apparatus and used as inputs to the AI/ML model.

6. The apparatus of claim 1, wherein the first apparatus is further caused to perform:
receiving, from the second apparatus, acknowledgement of the test configuration information; and
based on receiving the acknowledgement of the test configuration information, causing the test plan to be executed.

7. The apparatus of claim 1, wherein the first apparatus is further caused to perform:
based on a determination that the at least one predicted channel indicator matches with the at least one test channel indicator, determining the test result to indicate that the AI/ML model is validated; and
based on a determination that the at least one predicted channel indicator mismatches with the at least one test channel indicator, determining the test result to indicate that the AI/ML model is invalidated.

8. The apparatus of claim 1, wherein the first apparatus comprises testing equipment, and the second apparatus comprises a device under test.

9. The apparatus of claim 8, wherein the testing equipment comprises a network entity, a base station, or a terminal device, and
wherein the device under test comprises a network entity, a base station, or a terminal device, wherein the terminal device comprises one or more receivers.

10. A second apparatus comprising:
at least one processor; and
at least one memory storing instructions that, when executed by the at least one processor, cause the second apparatus at least to perform:
receiving test configuration information from a first apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel;
based on the test configuration information, deriving at least one predicted channel indicator for the at least one TRP using the AI/ML model; and
transmitting, to the first apparatus, at least one predicted channel indicator for the at least one TRP.

11. The apparatus of claim 10, wherein the test configuration information comprises at least one of the following:
an indication of the AI/ML model to be tested,
an indication of the at least one TRP, or
an indication of the test mode, a test command, or a test configuration.

12. The apparatus of claim 10, wherein the second apparatus is further caused to perform:
transmitting, to the first apparatus, acknowledgement of the test configuration information, to trigger the test plan to be executed.

13. The apparatus of claim 10, wherein the second apparatus is caused to perform:
measuring reference signals transmitted from the at least one TRP; and
providing the measurement results of reference signals as inputs to the AI/ML model to derive the at least one predicted channel indicator.

14. The apparatus of claim 10, wherein the first apparatus comprises testing equipment, and the second apparatus comprises a device under test.

15. The apparatus of claim 14, wherein the testing equipment comprises a network entity, a base station, or a terminal device, and
wherein the device under test comprises a network entity, a base station, or a terminal device, wherein the terminal device comprises one or more receivers.

16. A method for a second apparatus, comprising:
receiving test configuration information from a first apparatus, the test configuration information indicating a test mode of an artificial intelligence/machine learning (AI/ML) model with respect to at least one transmission and reception unit (TRP), the at least one TRP being arranged within an environment based on a test plan for at least one test channel indicator, a test channel indicator indicating a probability of a communication channel between the second apparatus and a TRP being a line-of-sight channel or a non-line-of-sight channel;
based on the test configuration information, deriving at least one predicted channel indicator for the at least one TRP using the AI/ML model; and
transmitting, to the first apparatus, at least one predicted channel indicator for the at least one TRP.

17. The method of claim 16, wherein the test configuration information comprises at least one of the following:
an indication of the AI/ML model to be tested,
an indication of the at least one TRP, or
an indication of the test mode, a test command, or a test configuration.

18. The method of claim 16, further comprising:
transmitting, to the first apparatus, acknowledgement of the test configuration information, to trigger the test plan to be executed.

19. The method of claim 16, further comprising:
measuring reference signals transmitted from the at least one TRP; and
providing the measurement results of reference signals as inputs to the AI/ML model to derive the at least one predicted channel indicator.
